(19) United States
(12) Patent Application Publication
(10) Pub. No.: US 2011/0091250 A1
(43) Pub. Date: Apr. 21, 2011

(54) FIXING APPARATUS OF IMAGE FORMING APPARATUS

(75) Inventor: Kazuhiko Kikuchi, Yokohama-shi (JP)

(73) Assignees: KABUSHIKI KAISHA TOSHIBA, Tokyo (JP); TOSHIBA TEC KABUSHIKI KAISHA, Tokyo (JP)

(21) Appl. No.: 12/978,817

(22) Filed: Dec. 27, 2010

Related U.S. Application Data
(62) Division of application No. 11/947,400, filed on Nov. 29, 2007.
(60) Provisional application No. 60/867,920, filed on Nov. 30, 2006.
(60) Provisional application No. 60/867,927, filed on Nov. 30, 2006.

(51) Int. Cl. G03G 15/20

(52) U.S. Cl. 399/329

(57) ABSTRACT

A fixing apparatus of an embodiment of the invention includes an auxiliary pressure member to press a belt to a heat roller side. A belt mechanism to integrally support the belt and the auxiliary pressure member is rotated so that the belt is spaced from the heat roller except for a necessary time. The temperature gradient characteristic of the surface temperature of the heat roller is compared with a reference temperature gradient characteristic, and a correction value of power supplied to a coil is estimated. The correction value is added to the supply power obtained from the detection result of a sensor, and control power for controlling an inverter drive circuit is obtained.

### CROSS REFERENCE TO RELATED APPLICATION

This application is a Divisional of application Ser. No. 11/947,400 filed on Nov. 29, 2007, the entire contents of which are incorporated herein by reference.

This invention is based upon and claims the benefit of priority from prior U.S. Patent Applications 60/867,920 and 60/867,927 filed on Nov. 30, 2006, the entire contents of which are incorporated herein by reference.

### BACKGROUND OF THE INVENTION

1. Field of the Invention

The present invention relates to a fixing apparatus mounted in an image forming apparatus such as a copier, a printer or a fax, and particularly to a fixing apparatus of an image forming apparatus, which uses an induction heating system.

2. Description of the Background

In recent years, there is a fixing apparatus of an induction heating system used in an image forming apparatus such as a copier of an electrophotographic system or a printer. In the fixing apparatus of the induction heating system, there is an apparatus in which warming-up of the fixing apparatus is accelerated and the fixing speed is further increased. For example, U.S. Pat. No. 6,819,904 discloses an image device in which an exciting coil is disposed around a heat-generating roller and a warming-up time is shortened.

In the above related art device, the heat-generating roller at the side where it is in contact with a toner image is heated at high speed by the exciting coil, and the speed of image formation is increased. However, in the related art, since the heat source is placed only at the heat-generating roller side, in the case where color images are continuously fixed at high speed, when a large amount of heat is continuously consumed, especially the amount of heat at the pressure member side becomes insufficient, and there is a fear that defective quality of fixing image occurs.

Then, in an fixing apparatus in which the speedup is realized by the induction heating system, the development of the fixing apparatus of an image forming apparatus is desired in which insufficiency in quantity of heat is solved, and even at the time of high-speed continuous color image formation, poor fixing does not occur, and a high quality fixed image can be obtained.

### SUMMARY OF THE INVENTION

According to an aspect of the invention, the speed of image formation is increased by using a heat generating member to generate heat by an induction heating system, and fixing energy supplied to a fixed medium is increased in a nip between the heat generating member and an opposite member. By this, there is provided a fixing apparatus of an image forming apparatus in which defective quality of fixing image at the time of high-speed continuous color image formation is prevented and an excellent image is obtained.

According to an embodiment of the invention, a fixing apparatus of an image forming apparatus includes a heat generating member having a metal layer, a first induction current generating device disposed close to the heat generating member, a belt that is opposite to the heat generating member, is rotatably supported by plural rollers, and comes in contact with the heat generating member, and a pressing member that presses the belt to the heat generating member and forms a nip between the heat generating member and the belt at a time when the heat generating member and the belt are in contact with each other.

### BRIEF DESCRIPTION OF THE DRAWINGS

FIG. 1 is a schematic structural view showing an image forming apparatus of a first embodiment of the invention;

FIG. 2 is a schematic structural view in which a fixing apparatus of the first embodiment of the invention is seen in an axial direction;

FIG. 3 is a schematic sectional view showing a surface layer of a heat roller of the first embodiment of the invention;

FIG. 4 is a schematic sectional view showing a belt of the first embodiment of the invention;

FIG. 5 is a graph showing a reduction in temperature after copying in the fixing apparatus of the first embodiment of the invention and in a comparative example;

FIG. 6 is a comparison table showing fixing performance of the fixing apparatus of the first embodiment of the invention and the comparative example;

FIG. 7 is a graph showing a non-offset region of the fixing apparatus obtained by a fixing performance test in the first embodiment of the invention;

FIG. 8 is a graph showing a non-offset region of the comparative example obtained by the fixing performance test in the first embodiment of the invention;

FIG. 9 is a schematic explanatory view showing a state where the belt of the first embodiment of the invention is spaced from the heat roller;

FIG. 10 is a schematic explanatory view showing a state where a belt mechanism is rotated while an opposite roller is made the rotation center in the first embodiment of the invention;

FIG. 11 is a schematic explanatory view showing a state where the belt mechanism is slid and moved, and is rotated while the opposite roller is made the rotation center in the first embodiment of the invention;

FIG. 12 is a schematic circuit diagram showing a control system of the first embodiment of the invention;

FIG. 13 is a graph showing a temperature gradient of the heat roller of the first embodiment of the invention;

FIG. 14 is a power correction table showing power correction values based on the temperature gradient of the heat roller of the first embodiment of the invention;

FIG. 15 is a second power correction table showing power correction values based on the weight of a fixed medium of the first embodiment of the invention;

FIG. 16 is a flowchart showing warm-up of the heat roller and the belt of the first embodiment of the invention;

FIG. 17 is a schematic structural view of a fixing apparatus of a first modified example of the invention seen from an axial direction; and

FIG. 18 is a schematic structural view of a fixing apparatus of a second modified example of the invention seen from an axial direction.

### DETAILED DESCRIPTION OF THE INVENTION

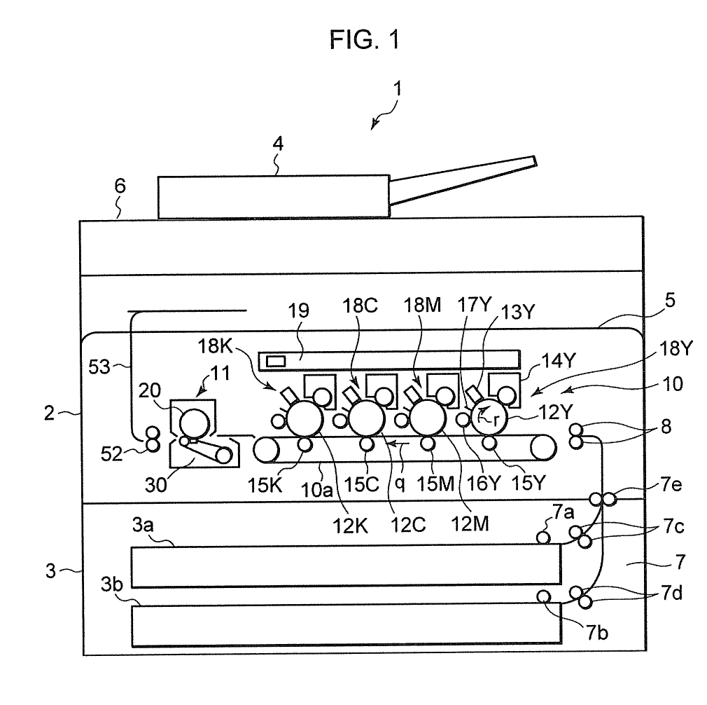

Hereinafter, a first embodiment of the invention will be described in detail with reference to the accompanying drawings. FIG. 1 is a schematic structural view showing an image forming apparatus 1 of a first embodiment of the invention. The image forming apparatus 1 includes a scanner unit 6 to read an original document, and a paper feed unit 3 to feed a sheet paper P as a fixed medium to a printer unit 2 to form an image. The scanner unit 6 converts image information read from an original document supplied by an auto document feeder 4 provided on an upper surface into an analog signal.

The printer unit 2 includes an image forming unit 10 in which image forming stations 18Y, 18M, 18C and 18K of respective colors of yellow (Y), magenta (M), cyan (C) and black (K) are arranged in tandem along a transfer belt 10a rotated in an arrow q direction. Further, the image forming unit 10 includes a laser exposure apparatus 19 to irradiate a laser beam corresponding to image information to photoconductive drums 12Y, 12M, 12C and 12K of the image forming stations 18Y, 18M, 18C and 18K of the respective colors. Further, the printer unit 2 includes a fixing apparatus 11 and a paper discharge roller 52, and includes a paper discharge transport path 53 for transporting the sheet paper P after fixing to a paper discharge unit 5.

The image forming station 18Y of yellow (Y) of the image forming unit 10 is constructed such that a charger 13Y, a developing apparatus 14Y, a transfer roller 15Y, a cleaner 16Y, and a charge removal unit 17Y are disposed around the photoconductive drum 12Y rotating in an arrow r direction. The image forming stations 18M, 18C and 18K of the respective colors of magenta (M), cyan (C) and black (K) have the same structure as the image forming station 18Y of yellow (Y).

The paper feed unit 3 includes a first and a second paper feed cassettes 3a and 3b. Pickup rollers 7a and 7b to take out the sheet paper P from the paper feed cassettes 3a and 3b, separating transport rollers 7c and 7d, a transport roller 7e and a register roller 8 are provided on a transport path 7 of the sheet paper P extending from the paper feed cassettes 3a and 3b to the image forming unit 10.

By the start of a print operation, in the image forming station 18Y of yellow (Y) of the printer unit 2, the photoconductive drum 12Y is rotated in the arrow r direction and is uniformly charged by the charger 13Y. Next, the laser exposure device 19 irradiates the photoconductive drum 12Y with an exposure light corresponding to the image information of yellow (Y) read by the scanner unit 6, and an electrostatic latent image is formed. Thereafter, the photoconductive drum 12Y is supplied with toner by the developing apparatus 14Y, and a toner image of yellow (Y) is formed on the photoconductive drum 12Y. The toner image of yellow (Y) is transferred at the position of the transfer roller 15Y to the sheet paper P transported in the arrow q direction on the transfer belt 10a. After the transfer of the toner image is ended, the residual toner on the photoconductive drum 12Y is cleaned by the cleaner 16Y, the electricity on the surface of the photoconductive drum 12Y is removed by the charge removal unit 17Y, and the next printing is enabled.

Also in the image forming stations 18M, 18C and 18K of the respective colors of magenta (M), cyan (C) and black (K), toner images are formed similarly to the image forming station 18Y of yellow (Y). The toner images of the respective colors formed by the image forming stations 18M, 18C and 18K are sequentially transferred at the respective positions of the transfer rollers 15M, 15C and 15K to the sheet paper P on which the toner image of yellow (Y) was formed. In this way, the sheet paper P on which the color toner images are formed is heated, pressed and fixed by the fixing apparatus 11, the print image is completed, and the sheet paper is discharged to the paper discharge unit 5.

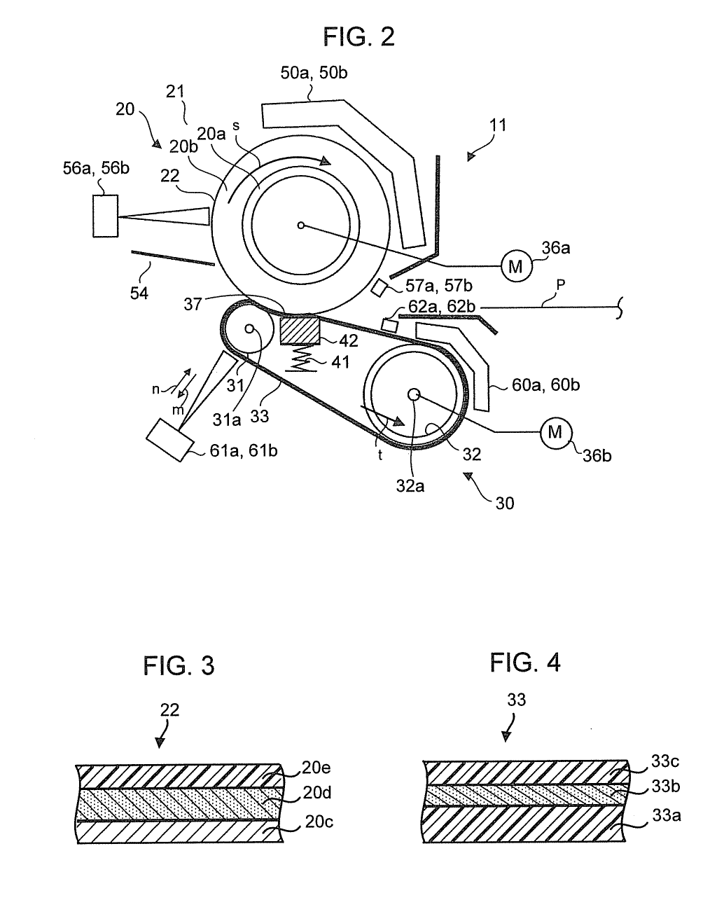

Next, the fixing apparatus 11 will be described. FIG. 2 is a schematic structural view in which the fixing apparatus 11 is seen in an axial direction. The fixing apparatus 11 is a heat generating member and includes a heat roller 20 having an outer diameter of 50 mm. A unitized belt mechanism 30 is disposed at a position opposite to the heat roller 20. The belt mechanism 30 includes an endless belt 33 supported by plural rollers, i.e., an opposite roller 31 and a metal roller 32. Further, the belt mechanism 30 includes an auxiliary pressure member 42 as a pressing member to widen a nip width. The auxiliary pressure member 42 is pressed by a spring 41, presses the belt 33 to the heat roller 20, and forms a nip 37 with a specific width between the heat roller 20 and the belt 33.

The heat roller 20 is rotated in an arrow s direction by a first fixing motor 36a. The belt 33 is rotated in an arrow t direction by the rotation of the metal roller 32 by a second fixing motor 36b. The heat roller 20 and the belt 33 nip the sheet paper P at the nip 37 and transports it in the direction toward the paper discharge roller 32. The sheet paper P passes through the nip 37 between the heat roller 20 and the belt 33, so that the toner image on the sheet paper P is heated, pressed and fixed. Incidentally, a drive mechanism of the heat roller 20 and the belt 33 is not limited, and for example, the heat roller 20 and the belt 33 may be rotated by the same fixing motor.

The heat roller 20 includes an elastic roller 21 and a surface layer 22. The elastic roller 21 includes a metal shaft 20a made of, for example, iron (Fe) or aluminum, and a foamed silicone rubber layer 20b as an elastic layer disposed therearound. The metal shaft 20a may be solid or hollow. The foamed silicone rubber layer 20b has heat resistance and heat insulation, and is formed of, for example, a microcellular foamed material of continuous foam having an average cell diameter of about 150 microns.

As shown in FIG. 3, the surface layer 22 includes a silicone rubber layer 20d having, for example, a thickness of 0.1 to 0.5 mm on the surface of a metal conductive layer 20c as a metal layer formed of, for example, nickel (Ni) and having a thickness of 30 to 50 μm. Further, the surface layer 22 includes a release layer 20e formed on the surface of the silicone rubber layer 20d. The release layer 20e is made of, for example, fluorine resin (PFA or PTFE (polytetrafluoroethylene) or a mixture of PFA and PTFE). The thickness of the release layer 20e is, for example, 0.02 to 0.1 mm. Incidentally, the metal layer is not limited to nickel, and may be made of magnetic stainless, iron or the like. The metal layer may be made of any material as long as it has an excellent heat efficiency in the induction heating system.

The foamed silicone rubber layer 20b of the elastic roller 21 thermally insulates the metal shaft 20a from the metal conductive layer 20c. By this, it becomes possible to keep the heat capacity of the whole heat roller 20 low. Besides, the foamed silicone rubber layer 20b has a thickness of, for example, about 5 to 15 mm in order to keep the nip 37 formed between itself and the belt 33 wide and in order to keep such a distance that a magnetic flux generated from an induction current generating device does not have an influence on the metal shaft 20a. When the foamed silicone rubber layer 20b is excessively thick, the stress at the boundary surface between itself and the metal shaft 20a becomes large by the torque (load) caused by the rotation of the heat roller 20, and there is a possibility of breakage, and therefore, it is desirable that the thickness is 15 mm or less. Besides, it is preferable that the rubber hardness of the foamed silicone rubber layer 20b is ASKER C 20 to 40°.

The metal shaft 20a and the foamed silicone rubber layer 20b of the elastic roller 21 are fixed to each other. In the surface layer 22, the metal conductive layer 20c and the silicone rubber layer 20d, and the silicone rubber layer 20d and the release layer 20e are also fixed to each other. However, the foamed silicon rubber layer 20b and the metal conductive layer 20c are not adhered to each other.

At room temperature (25° C.), the elastic roller 21 has an outer diameter smaller than an inner diameter of the surface layer 22 by, for example, about 0.2 mm to 0.7 mm. Accordingly, since the surface layer 22 is not adhered and not fixed to the elastic roller 21, the surface layer 22 can slide on the elastic roller 21, and when the surface layer 22 reaches the end of its life, it can be replaced. The elastic roller 21 is thermally expanded by heating. For example, when the surface of the heat roller 20 is left in a state of a fixable temperature of 170° C., the foamed silicone rubber layer 20b is gradually expanded. In the state where the foamed silicone rubber layer 20b is expanded as stated above, the outer diameter of the elastic roller 21 becomes larger than the inner diameter of the surface layer 22 by, for example, about 0.2 to 0.5 mm. By this, the surface layer 22 is fitted to the elastic roller 21 in the state where the elastic layer 21 is compressed. Incidentally, the structure of the heat roller 20 is not limited, and the foamed silicone rubber layer 20b and the metal conductive layer 20c may be adhered to each other to be integrally formed.

As shown in FIG. 4, the belt 33 of the belt mechanism 30 is constructed such that for example, an elastic layer 33b made of heat resistant rubber such as silicone rubber, and a release layer 33c made of fluorine resin such as PFA are formed on a base member 33a made of heat-resistant resin such as polyimide resin. The thickness of the base member 33a is, for example, 0.1 to 0.5 mm. The belt 33 is not limited to the resin, and metal powder may be dispersed in the base member. By this, the belt 33 itself can be heated by induction heating. Besides, the metal roller 32 as one of the rollers supporting the belt 33 is made of magnetic stainless. However, the metal roller is not limited to this, and iron, nickel or the like may be used as long as the heat efficiency in the induction heating system is excellent.

The opposite roller 31 to support the belt 33 of the belt mechanism 30 is in contact with the heat roller 20 through the belt 33. By this, the belt 33 is brought into pressure contact with the heat roller at the position of the opposite roller 31. Further, the belt 33 is pressed to the heat roller 20 by the auxiliary pressure member 42. The auxiliary pressure member 42 is made of silicone rubber whose section is rectangular, and the corner of the rectangle is formed into a round R-shape. By providing the auxiliary pressure member 42, the nip 37 extending from the opposite roller 31 to the auxiliary pressure member 42 and having a specific width of, for example, 14 mm is formed between the heat roller 20 and the belt 33. The auxiliary pressure member 42 is pressed by the spring 41 and applies a load of 400 N to the nip 37.

As stated above, in this embodiment, by using the auxiliary pressure member 42, even if a large load is not applied, the nip having the necessary desired width can be obtained between the heat roller 20 and the belt 33.

Next, a relation between a load to the nip and a reduction in temperature of the heat roller 20 and the belt 33 will be described. In general, under a common condition, in order to widen the nip width, the load must be increased. The load causes adhesion force between the sheet paper and the heat roller 20 and between the sheet paper and the belt 33 to be increased. In physical properties, there is an effect to reduce the contact heat resistance between the sheet paper and the heat roller 20 and between the sheet paper and the belt 33. Accordingly, that the load of the nip is increased means that the heat conductivity between the sheet paper and the heat roller 20 and between the sheet paper and the belt 33 is improved. That is, that the load of the nip is increased causes the reduction in temperature of the heat roller 20 and the belt 33. From this, in order to prevent the reduction in the temperature of the heat roller 20 and the belt 33 at the time of fixation and to keep the fixable temperature, it is better that the load of the nip is low.

On the other hand, when the load of the nip is decreased, heat transfer to the sheet paper is naturally decreased, and therefore, it is estimated that a disadvantage occurs in fixing properties. One of countermeasures of compensating this is to widen the nip width. However, as described before, under the common condition, in order to widen the nip width, the load must be increased.

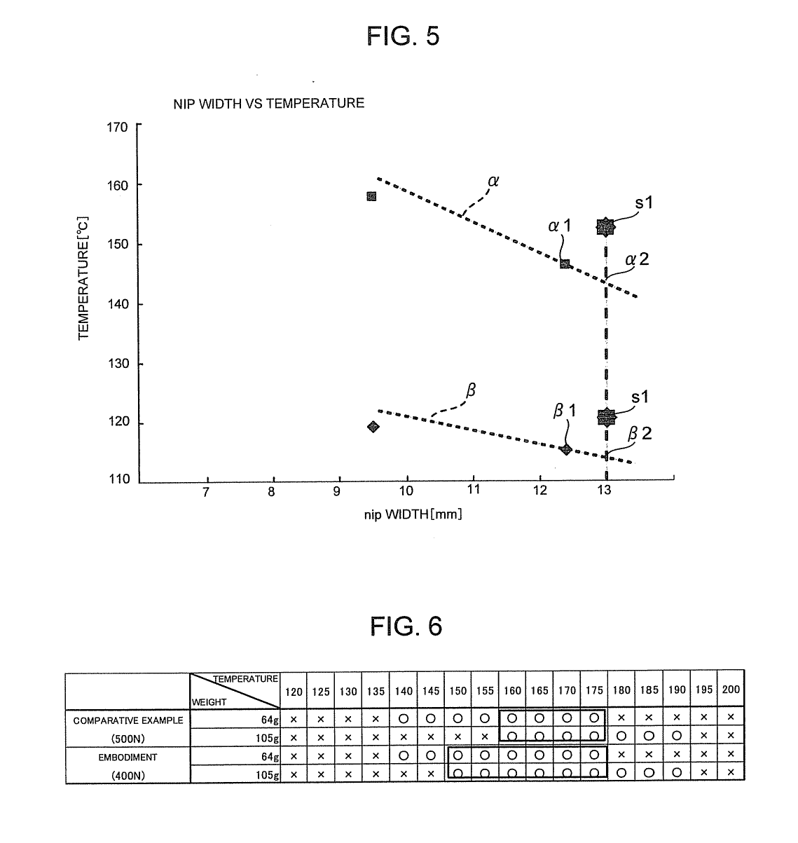

For example, as a comparative example, the belt mechanism 30 of this embodiment is replaced by a press roller in which a silicone rubber layer and a release layer are provided around a hollow metal shaft and which has an outer diameter of 50 mm, and a fixing test is performed while the nip width between the heat roller 20 and the press roller is changed, and results shown in FIG. 5 are obtained. In FIG. 5, 1000 W is supplied to the heat roller 20, 300 W is supplied to the press roller, and the load is changed, so that the nip width is changed from 10.5 mm to 14.5 mm. At each nip width, 500 pieces of standard paper are continuously copied. When the surface temperature of the heat roller 20 and the press roll at the nip exit after copying is detected, the result indicated by a dotted line a is obtained for the heat roller 20, and the result indicated by a dotted line β is obtained for the press roller.

In FIG. 5, α1 and β1 denote the nip width and the temperature detection result at the time when the load of the nip is made 500 N. From this result, in the comparative example, in order to widen the nip width, the load must be increased. On the other hand, in the case where the load is increased, the surface temperature of the heat roller 20 and the press roller is reduced. In this comparative example, a load of 500 N or higher is applied to the nip, a nip width of 14 mm is kept, and a continuous fixing test of 500 sheets is performed. As a result, as indicated by α2 and β2 of FIG. 5, the surface temperature of the heat roller 20 becomes 145° C. or lower. Besides, the surface temperature of the press roller becomes 115° C. or lower.

On the other hand, a test example is used in which an elastic member with low hardness is used for the elastic layer at the side of the heat roller 20 of the comparative example, and the nip width of 14 mm is obtained when the load of the nip is made 400 N, and a similar fixing test is performed. As a result, as indicated by S1 and S2 of FIG. 5, the surface temperature of the heat roller is kept 150° C. or higher, and the surface temperature of the press roller is kept 120° C. or higher.

Thus, in this embodiment, the auxiliary pressure member 42 is provided, the load of the nip 37 is suppressed to 400 N, and the nip width of 14 mm is secured. The fixing performance of the heat roller 20 and the press roller used in the comparative example and that of the heat roller 20 and the belt mechanism 30 of this embodiment are evaluated by comparing the range of a non-offset region. In the evaluation method, the nip load between the heat roller 20 and the belt 33 of this embodiment is made 400 N, and the nip width is made 14 mm. On the other hand, the nip load between the heat roller 20 and the press roller of the comparative example is made 500 N, and the nip width is made 13.5 mm. The surface temperature of the heat roller 20 is set to 120° C. to 200° C., and with respect to a standard paper which weight is in a range of 64 to 105 g/m², 64 g/m² paper and 105 g/m² paper are sampled and the fixing test is performed.

As a result, as shown in FIG. 6, in the case of this embodiment, when the heat roller temperature is 150° C. to 175° C., all the standard papers can be excellently fixed. As compared with this, in the case of the comparative example, the temperature at which all the standard papers can be excellently fixed is 160° C. to 175° C. In FIG. 6, ◯ denotes good, and x denotes defective quality of fixing image. As the defective quality of fixing image, at the time of high temperature, there is an offset (high temperature offset) caused since the toner is kept in a melted state. At the time of low temperature, there is an offset (low temperature offset) in which the toner can not be completely melted.

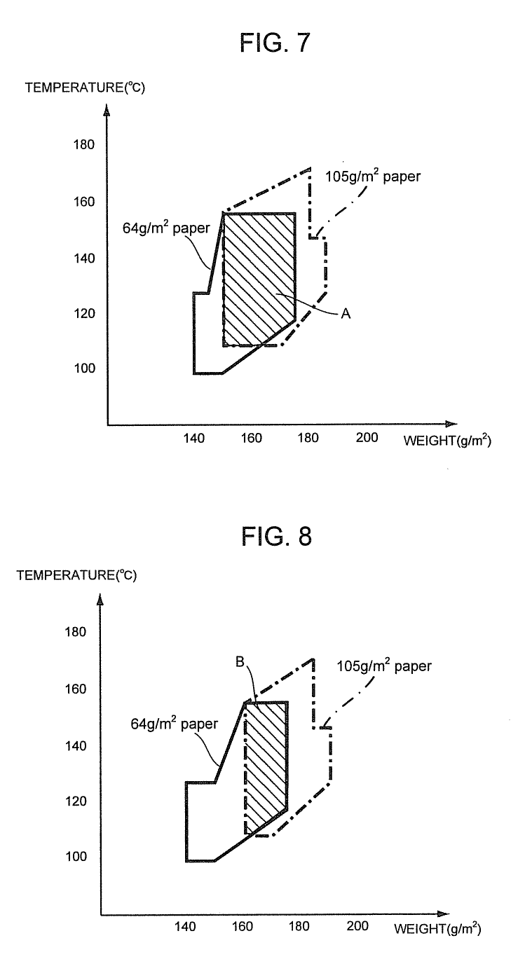

This result is shown in a graph. FIG. 7 shows the fixing result obtained for the heat roller 20 and the belt 33 of this embodiment, and excellent fixing performance is obtained in a region A indicated by oblique lines. On the other hand, FIG. 8 shows the fixing result obtained for the heat roller 20 and the press roller of the comparative example, and excellent fixing performance is obtained in a region B indicated by oblique lines. That is, as compared with the comparative example, in the heat roller 20 and the belt 33 of this embodiment, the non-offset region becomes wide and the fixing property is improved.

Incidentally, the shape, the structure and the like of the auxiliary pressure member 42 are arbitrary, and for example, the auxiliary pressure member is divided into plural blocks by using materials different from each other in hardness, and the load may be changed in the nip 37. When the load of the auxiliary pressure member made of the plural blocks is set so that the load at the discharge side becomes large as compared with that at the insertion side of the sheet paper P in the fixing apparatus 11, the peeling property of the sheet paper P from the heat roller 20 can be improved.

A peel pawl 54, a first and a second induction current generating coils 50a and 50b as a first induction current generating device, a first and a second thermistors 56a and 56b which are heat generation member temperature sensors and are not in contact with the heat roller 20, and a first and a second thermostats 57a and 57b are provided around the heat roller 20 of the fixing apparatus 11. The peel pawl 54 prevents the sheet paper P after fixation from winding around the heat roller 20. The peel pawl 54 may be of a contact type or a non-contact type.

The first and the second induction current generating coils 50a and 50b are disposed with a predetermined gap from the outer periphery of the heat roller 20, and heats the metal conductive layer 20c of the heat roller 20. The first induction current generating coil 50a heats the center area of the heat roller 20, and the second induction current generating coil 50b heats areas of the heat roller 20 at both sides. Accordingly, in the case where fixing of the sheet paper P of a small size is performed, power is supplied to the first induction current generating coil 50a to heat the center area of the heat roller 20, while power supply to the second induction current generating coil 50b is stopped.

In the case where the whole length of the heat roller 20 is heated, the first and the second induction current generating coils 50a and 50b are alternately switched to perform output, and both are set so that an adjustment can be made up to, for example, 200 W to 1500 W. The first and the second induction current generating coils 50a and 50b may simultaneously output. In the case of the simultaneous output, the output values of the first induction current generating coil 50a and of the second induction current generating coil 50b can be respectively changed. For example, in the case where the number of sheet papers P passing through the center area of the heat roller 20 is larger than that at both sides, the output of the first induction current generating coil 50a can be made larger than the output of the second induction current generating coil 50b.

The first and the second induction current generating coils 50a and 50b are formed such that a wire is wound around a magnetic core to concentrate a magnetic flux to the heat roller 20. As the wire, for example, a litz wire is used which is constructed such that plural copper wires which are coated with heat resistant polyamide and are insulated from each other are bundled. When the wire is made the litz wire, the diameter of the wire can be made smaller than the penetration depth of the magnetic field. By this, a high frequency current can be made to effectively flow through the wire. In this embodiment, 40 copper wires each having a diameter of 0.3 mm are bundled to form the litz wire.

When a predetermined high frequency current is supplied to the litz wire as stated above, the first and the second induction current generating coils 50a and 50b generate the magnetic flux. By this magnetic flux, an eddy current is generated in the metal conductive layer 20c so as to prevent the change of the magnetic field. Joule heat is generated by this eddy current and the resistance value of the metal conductive layer 20c, and the heat roller 20 is instantaneously heated.

As the first and the second thermistors 56a and 56b which are not in contact with the heat roller 20, for example, an infrared temperature sensor of a thermopile type is used. The infrared temperature sensor of the thermopile type receives infrared rays, calculates the energy of the infrared rays, and detects, as electromotive force of a thermocouple, a temperature change at a heat contact part generated in the thermopile. The first thermistor 56a detects the surface temperature of almost the center of the heat roller 20 and converts it into a voltage. The second thermistor 56b detects the surface temperature of the side of the heat roller 20 and converts it into a voltage.

The first thermostat 57a detects the trouble of the surface temperature of the center part of the heat roller 20. The second thermostat 57b detects the trouble of the surface temperature of the side of the heat roller 20. In the case where the first or the second thermostat 57a or 57b detects the trouble, the supply of power to the first and the second induction current generating coils 50a and 50b is forcibly turned off.

A third and a fourth induction current generating coils 60a and 60b as a second induction current generating device are provided around the belt 33 and at a position opposite to the metal roller 32. A third and a fourth thermostats 62a and 62b are provided around the belt 33 at a position after passing the third and the fourth induction current generating coils 60a and 60b. A third and a fourth thermistors 61a and 61b each made of an infrared temperature sensor of a thermopile type, which is a belt temperature sensor and is in non-contact with the belt 33, are provided around the belt 33 at a position after passing the nip 37.

The third induction current generating coil 60a heats the center part of the metal roller 32 in the width direction, and the fourth induction current generating coil 60b heats both sides of the metal roller 32 in the width direction. Accordingly, in the case where fixing of the sheet paper P of a small size is performed, power is supplied to the third induction current generating coil 60a to heat the center part of the metal roller 32, while the supply of power to the fourth induction current generating coil 60b is stopped. In order to heat the whole length of the metal roller 32, the third and the fourth induction current generating coils 60a and 60b are alternately switched to perform output, and both are set so that an adjustment can be made up to, for example, 200 W to 1200 W. Incidentally, the third and the fourth induction current generating coils 60a and 60b may simultaneously output. The third and the fourth induction current generating coils 60a and 60b are formed similarly to the first and the second induction current generating coils 50a and 50b. The metal roller 32 is instantaneously heated by the magnetic flux of the third and the fourth induction current generating coils 60a and 60b and heats the belt 33.

The third thermistor 61a detects the surface temperature of almost the center of the belt 33 in the width direction and converts it into a voltage. The fourth thermistor 61b detects the surface temperature of the side of the belt 33 in the width direction, and converts it into a voltage. The third thermostat 62a detects the trouble of the surface temperature of the center part of the belt 33 in the width direction. The fourth thermostat 62b detects the trouble of the surface temperature of the side of the belt 33 in the width direction. In the case where the third or the fourth thermostat 62a or 62b detects the trouble, the supply of power to the third and the fourth induction current generating coils 60a and 60b is forcibly turned off.

On the other hand, in the belt mechanism 30, the opposite roller 31, the metal roller 32, the belt 33 and the auxiliary pressure member 42 can be integrally rotated while an axis 32a of the metal roller 32 is made the rotation center. The rotation of the belt mechanism 30 is performed by, for example, the rotation of the second fixing motor 36b for rotating the belt 33.

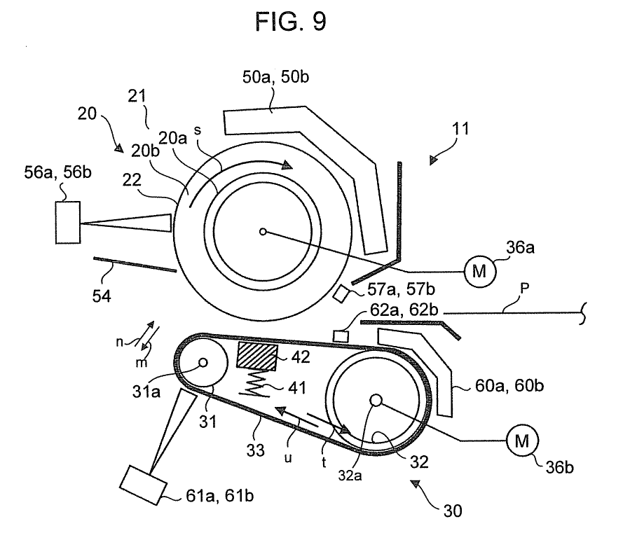

In the second fixing motor 36b, the direction in which the belt 33 is rotated in the arrow t direction is made a positive rotation, and the direction opposite thereto is made a reverse rotation. The second fixing motor is reversely rotated to rotate the belt 33 in the arrow u direction, and rotates, as shown in FIG. 9, the belt mechanism 30 around the axis 32a in the arrow m direction through a link mechanism such as a cam. By this, the belt 33 is spaced from the heat roller 20. At this time, the heat roller 20 is released from the load caused by the pressing of the belt 33. However, in this period, the metal roller 32 is disposed in a region where induction heating can be performed by the third and the fourth induction current generating coils 60a and 60b and is heated. Accordingly, the belt 33 can be heated by the metal roller 32 in the state where it is spaced from the heat roller 20. Besides, at this time, the third and the fourth thermistors 61a and 61b are also rotated integrally with the belt mechanism 30 in the same direction.

Thereafter, when the heat roller 20 and the belt 33 reach after-mentioned prerun temperature, the second fixing motor 36b is positively rotated. By this, the belt 33 is rotated in the arrow t direction, and the belt mechanism 30 is rotated in the arrow n direction around the axis 32a through the link mechanism. As a result, the belt 33 comes in contact with the heat roller 20, and the nip 37 is formed between the heat roller 20 and the belt 33.

As stated above, in the belt mechanism 30, even in the period when the belt 33 is spaced from the heat roller 20, the metal roller 32 is disposed in the region where induction heating can be performed by the third and the fourth induction current generating coils 60a and 60b. Accordingly, the belt 33 is heated by the metal roller 32 even in the period when it is spaced from the heat roller 20. Further, while the belt 33 is heated by the metal roller 32, it is always rotated by the second fixing motor 36b. Accordingly, there is no fear that the belt is erroneously heated at the time of stop of rotation. As a result, the belt 33 is not overheated and the safety at the time of fixing can be obtained.

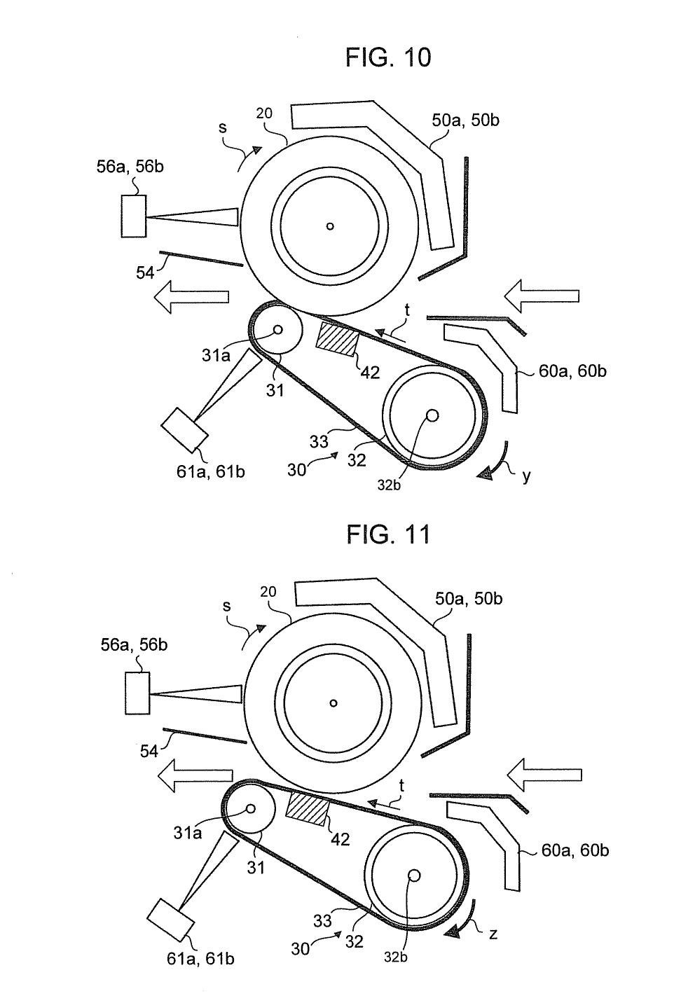

Incidentally, in order to reduce the load to the heat roller 20 caused by the belt 33, as shown in FIG. 10, the belt mechanism 30 may be rotated in an arrow y direction while an axis 31a of the opposite roller 31 is made the rotation center. By doing so, the metal roller 32 is disposed outside of the region where induction heating can be performed by the third and the fourth induction current generating coils 60a and 60b, and there is no fear of heat generation. Accordingly, in the apparatus in which it is unnecessary to heat the belt 33 during the period when the heat roller 20 is released from the pressing of the auxiliary member 42, there is no fear that the metal roller 32 is erroneously induction heated during the stoppage of the belt 33. As a result, the belt 33 is not overheated, and the safety of the fixing apparatus can be obtained.

Incidentally, in FIG. 10, when the belt mechanism 30 is rotated in the arrow y direction, the belt 33 is in contact with the heat roller 20 at the position of the opposite roller 31, and the load applied to the heat roller 20 is not zero. Thus, as shown in FIG. 11, the whole belt mechanism 30 is slid and moved, and the opposite roller 31 may be disposed at a position slightly spaced apart from the heat roller 20. That is, in FIG. 11, the opposite roller 31 and the heat roller 20 are disposed to be spaced from each other. In the arrangement as stated above, when the belt mechanism 30 is rotated in the arrow z direction while the axis 31a is made the rotation center, the belt 33 is completely spaced from the heat roller 20. Accordingly, in FIG. 11, when the belt mechanism 30 is rotated in the arrow z direction, the load applied to the heat roller 20 becomes zero. Further, maintenance such as an eliminating process of jam becomes easy.

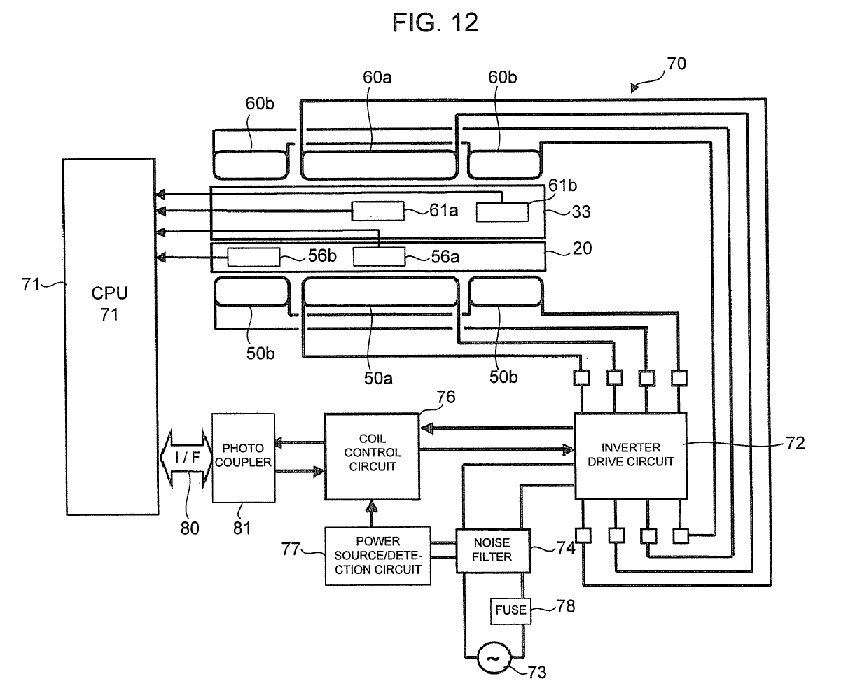

Next, a control system 70 to perform the temperature control of the heat roller 20 and the belt 33 will be described with reference to FIG. 12. The control system 70 includes, at a secondary side, a CPU 71 as a control unit to control the whole image forming system including an option apparatus such as a document feeder, a finisher or a fax. On the other hand, the control system 70 includes, at a primary side, an inverter drive circuit 72 to supply drive power to the first and the second induction current generating coils 50a and 50b, and the third and the fourth induction current generating coils 60a and 60b, a noise filter 74 to rectify a current from a commercial AC power source 73 and to supply it to the inverter drive circuit 72, a coil control circuit 76 to control the inverter drive circuit 72, a power source detection circuit 77 to detect the output of the noise filter 74 and to perform feedback so that the power from the commercial AC power source 73 becomes constant, and a fuse 78.

An interface 80 of the CPU 71 at the secondary side performs transmission and reception with respect to the coil control circuit 76 at the primary side through a photocoupler 81. By using the photocoupler 81, the secondary side and the primary side of the control system 70 can be insulated from each other. Temperature detection results obtained by the first and the second thermistors 56a and 56b and the third and the fourth thermistors 61a and 61b are inputted to the CPU 71.

The CPU 71 controls a high voltage power source necessary for printing of the image forming apparatus 1, controls a motor used for transport of the sheet P, and controls other operations of the image forming apparatus 1. In the case where the inverter drive circuit 72 is feedback controlled, the CPU 71 corrects the power supplied from the inverter drive circuit 72 to the first and the second induction current generating coils 50a and 50b or to the third and the fourth induction current generating coils 60a and 60b.

The power supplied to the first and the second induction current generating coils 50a and 50b or to the third and the fourth induction current generating coils 60a and 60b is always feedback controlled according to the detection temperatures obtained by the first and the second thermistors 56a and 56b and the third and the fourth thermistors 61a and 61b. However, since the power source voltage actually varies according to its characteristic or the installation environment of the image forming apparatus 1, the control value and the actual supply power become different from each other. Thus, when variation occurs in the surface temperature of the heat roller 20 or the belt 33 in spite of the feedback control of the CPU 71, a remarkable influence is exerted on the fixing performance. Then, the CPU 71 corrects the supply power by the feedback control in view of the variation of the characteristic of the power source voltage and the environmental state.

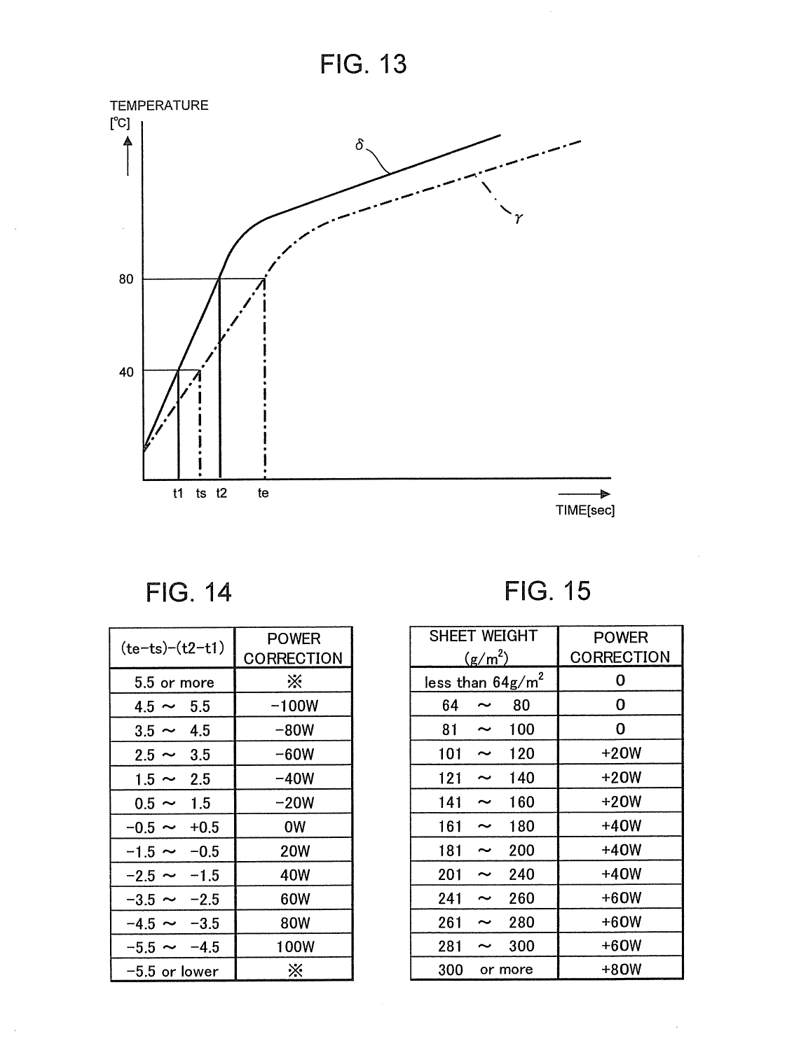

The correction of the supply power is performed by measuring the temperature gradient of the surface of the heat roller 20 in predetermined power setting at the time of warming-up of the image forming apparatus 1. However, at the time of warming-up, for example, in the case where 1000 W is supplied to the first and the second induction current generating coils 50a and 50b and 300 W is supplied to the third and the fourth induction current generating coils 60a and 60b, the surface temperature of the heat roller 20 has the temperature gradient characteristic shown in FIG. 13. That is, when the surface temperature of the heat roller 20 exceeds about 100° C., the temperature gradient becomes low angle by the influence of thermal diffusion to the outside. Thus, in the temperature region exceeding 100° C., the resolution for correction is reduced. Accordingly, after the warming-up is started and before the surface temperature of the heat roller 20 becomes 100° C., the CPU 71 measures the temperature rise gradient of the surface of the heat roller 20 and sets the correction value of the supply power.

Next, the estimation of the correction value will be described. In this embodiment, at the time of start of warming-up, the heat roller 20 and the belt 33 are spaced from each other. Thereafter, when the surface temperature of the heat roller 20 and the belt 33 reaches a predetermined prerun temperature, the heat roller 20 and the belt 33 are brought into contact with each other. Accordingly, the prerun temperature as the timing when the heat roller 20 and the belt 33 are brought into contact with each other is made 100° C., the temperature rise gradient of the heat roller 20 during the period when the heat roller 20 and the belt 33 are spaced from each other is measured, and the correction value of the supply power is estimated.

For example, in FIG. 13, after the power source is turned ON, the time elapsed before the surface temperature of the heat roller 20 reaches 40° C. to 80° C. is measured. An alternate long and short dash line γ of FIG. 13 indicates a reference temperature gradient characteristic, and a straight line δ indicates a temperature gradient characteristic obtained by actually measuring the heat roller 20 of this embodiment. A reference time in which the reference temperature gradient characteristic γ reaches 40° C. to 80° C. is denoted by “te−ts”. An actually measured time in which the actual temperature gradient characteristic δ of the heat roller 20 reaches 40° C. to 80° C. is denoted by “t2−t1”. The correction value of the supply power is estimated by {(te−ts)−(t2−t1)}=K. Further, the correction value is converted into a specific power value. An example of the conversion of the correction value is shown in a power correction table of FIG. 14.

In FIG. 14, for example, the power conversion correction value at the time when K is −0.5 to +0.5 is set to 0. As K becomes large, the minus power conversion correction value is increased. The power conversion correction value at the time when K is +4.5 to +5.5 is set to −100 W. However, in the case where K becomes 5.5 or more, it is determined to be a trouble, and a process to the trouble is performed. Besides, as K becomes smaller than −0.5, the plus power conversion correction value is increased. The power conversion correction value at the time when K is −5.5 to −4.5 is set to +100 W. However, in the case where K becomes −5.5 or lower, it is determined to be a trouble, and a process to the trouble is performed.

The correction of the power supplied to the first and the second induction current generating coils 50a and 50b or the third and the fourth induction current generating coils 60a and 60b is not limited to this, and the correction is made based on, for example, the weight or thickness of the sheet paper P to be fixed, and further, based on the size or the like.

For example, in the case where the power correction is performed according to the weight of the sheet paper P, a second power correction table shown in FIG. 15 is previously stored in a memory or the like of the CPU 71. In this embodiment, the supply power to the first and the second induction current generating coils 50a and 50b or the third and the fourth induction current generating coils 60a and 60b is set for the standard paper whose weight is in the range of 64 to 105 g/m². Accordingly, in this embodiment, when the weight of the sheet paper P is 64 to 100 g/m², the power conversion correction is made 0. Thereafter, as the weight of the sheet paper P is increased, the correction power is increased. For example, when the weight of the sheet paper P is 101 to 160 g/m², the power conversion correction is made 20 W, when the weight of the sheet paper P is 161 to 240 g/m², the power conversion correction is made 40 W, when the weight of the sheet paper P is 241 to 300 g/m², the power conversion correction is made 60 W, and when the weight of the sheet paper P is 300 g/m² or more, the power conversion correction is made 80 W.

Accordingly, at the time of the feedback control of the inverter drive circuit 72, the CPU 71 adds the power correction of FIG. 14 to the supply power value obtained from the detection result actually detected by the first and the second thermistors 56a and 56b or the third and the fourth thermistors 61a and 61b. Further, at the time of a copy mode, according to the kind of the sheet paper P, the power correction value of FIG. 15 is added.

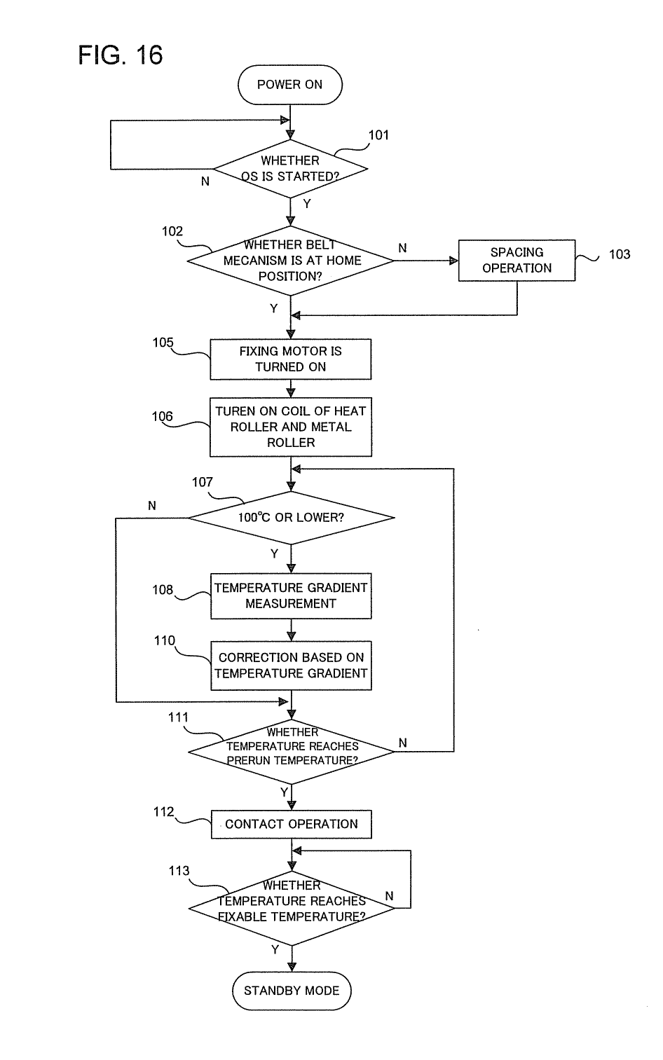

Next, temperature control of the heat roller 20 and the belt 33 by the control system 70 will be described by use of a flowchart of FIG. 16. During a period when the power source of the image forming apparatus 1 is turned off, as shown in FIG. 9, the belt mechanism 30 is rotated in the arrow m direction, and the belt 33 is spaced from the heat roller 20. When the power source of the image forming apparatus 1 is turned on in this state, the OS of the CPU 71 is started in order to control the whole image forming system. It is checked whether the OS of the CPU 71 is started (step 101), and when the OS is started, it is checked whether the belt mechanism 30 is located at the home position shown in FIG. 9 (step 102). In the case where the belt mechanism 30 is not located at the home position, a spacing operation to move the belt mechanism 30 to the home position is performed (step 103).

When the belt mechanism 30 is spaced from the heat roller 20 and is located at the home position, the first and the second fixing motors 36a and 36b are turned on, and the heat roller 20 and the belt 33 are respectively rotated (step 105). At this time, the belt 33 is rotated in the arrow u direction by the second fixing motor 36b. Next, power is supplied to the first and the second induction current generating coils 50a and 50b and the third and the fourth induction current generating coils 60a and 60b around the belt by the inverter drive circuit 72 (step 106), and warm-up is started. At this time, the total usable power is determined. Thus, the inverter drive circuit 72 optimally distributes the amount of power to the first and the second induction current generating coils 50a and 50b and the third and the fourth induction current generating coils 60a and 60b in the range of the power usable for the temperature control, and performs the feedback control.

During this, the correction value of the supply power of the inverter drive circuit 72 is set. Since the setting of the correction value is performed in the period when the surface temperature of the heat roller 20 is 100° C. or lower, it is checked whether the temperature detection result of the first and the second thermistors 56a and 56b is 100° C. or lower (step 107). When the temperature detection result is 100° C. or lower, the temperature gradient of the heat roller 20 is measured from the temperature detection result of the first and the second thermistors 56a and 56b (step 108). That is, the time “t2−t1” elapsed before the temperature detection result of the first and the second thermistors 56a and 56b reaches 40° C. to 80° C. is obtained.

Next, correction of the supply power is set from the temperature gradient of the heat roller 20 (step 110). That is, the time “te−ts” elapsed before the reference temperature gradient characteristic γ reaches 40° C. to 80° C. is obtained, {(te−ts)−(t2−t1)}=K is made the correction value of the supply power, this is further converted into a power value, and the power correction value is set. For example, when K is +1, −20 W is estimated as the power correction value. As the estimated power correction value, −20 W is stored in the memory or the like of the CPU 71. Next, when the supply power to the first and the second induction current generating coils 50a and 50b or the third and the fourth induction current generating coils 60a and 60b is feedback controlled according to the detection temperature of the first and the second thermistors 56a and 56b or the third and the fourth thermistors 61a and 61b, the CPU 71 makes a correction of −20 W, and controls the inverter drive circuit 72.

Thereafter, the inverter drive circuit 72 is feedback controlled by using the correction power value obtained by the execution of the correction. When the surface temperature of the heat roller 20 and the belt 33 reaches the predetermined prerun temperature at which the heat roller 20 and the belt 33 can be brought into contact with each other (step 111), the belt 33 is brought into contact with the heat roller 20 (step 112). After the temperature reaches the prerun temperature, the CPU 71 positively rotates the second fixing motor 36b to rotate the belt mechanism 30 in the arrow n direction. By this, the belt 33 is brought into contact with the heat roller 20, and the nip 37 is formed between the heat roller 20 and the belt 33. At this time, the load of the auxiliary pressure member 42 is 400 N, and the width of the nip 37 between the heat roller 20 and the belt 33 is 14 mm. The belt 33 is rotated in the arrow t direction by the positive rotation of the second fixing motor 36b.

On the other hand, at step 107, in the case where the temperature detection result of the first and the second thermistors 56a and 56b exceeds 100° C., advance is made to step 111 without measuring the temperature gradient of the heat roller 20. In the case where the temperature gradient of the heat roller 20 is not measured, for example, the former power correction value which is set by the former temperature gradient measurement and is stored in the memory of the CPU 71 is used as it is.

Thereafter, warm-up is continued, and it is checked whether the surface temperature of the heat roller 20 reaches, for example, 170° C., and the surface temperature of the belt 33 reaches, for example, 160° C. (step 113). At step 113, when the heat roller 20 and the belt 33 reach the fixable temperature, the warm-up is completed, and the image forming apparatus 1 is put in a standby mode.

At the time of the standby mode, the supply power to the first and the second induction current generating coils 50a and 50b or the third and the fourth induction current generating coils 60a and 60b is feedback controlled in order that the heat roller 20 and the belt 33 keep the fixable temperature. At the time of the feedback control, the CPU 71 adds the power correction value of −20 W to the power obtained from the detection result of the first and the second thermistors 56a and 56b, and obtains the supply power for control of the inverter drive circuit 72. Similarly, the power correction value of −20 W is added to the power obtained from the detection result of the third and the fourth thermistors 61a and 61b to obtain the supply power for control.

After the warm-up is completed, when a print instruction is issued from the CPU 71, the printer unit 2 starts the print operation, and forms a toner image on the sheet paper P by the image forming unit 10. Next, the sheet paper P having the toner image is made to pass through the nip 37 of a width of 14 mm between the heat roller 20 and the belt 33, and the toner image is heated, pressed and fixed. When the fixing operation is ended, the image forming apparatus 1 holds the standby mode, and then, in the case where there is no print instruction for a predetermined time, the image forming apparatus 1 becomes a preheat mode. Incidentally, in the case where the power source of the image forming apparatus 1 is turned off and the OS of the CPU 71 is turned off, the second fixing motor 36b is reversely rotated, the belt mechanism 30 is rotated in the arrow m direction, and the belt 33 is spaced from the heat roller 20.

In each of the modes, the CPU 71 always uses the temperature detection results from the first and the second thermistors 56a and 56b and the third and the fourth thermistors 61a and 61b and feedback controls the supply power to the first and the second induction current generating coils 50a and 50b or the third and the fourth induction current generating coils 60a and 60b, so that the surface temperatures of the heat roller 20 and the belt 33 are kept at the predetermined temperatures.

At the time of the feedback control in each of the modes, the CPU 71 adds the power correction value of −20 W to the power obtained from the detection result of the first and the second thermistors 56a and 56b, and obtains the first supply power for control of the inverter driver circuit 72. The inverter drive circuit 72 supplies the first supply power for control to the first and the second induction current generating coils 50a and 50b. Similarly, the power correction value of −20 W is added to the power obtained from the detection result of the third and the fourth thermistors 61a and 61b, and obtains the second supply power for control of the inverter drive circuit 72. The inverter drive circuit 72 supplies the second supply power for control to the third and the fourth induction current generating coils 60a and 60b.

At the time of the print operation, if necessary, according to the weight of the sheet paper P and in accordance with the second power correction table shown in FIG. 15, the CPU 71 further corrects the supply power to the first and the second induction current generating coils 50a and 50b or the third and the fourth induction current generating coils 60a and 60b.

When the setting control of the inverter drive circuit 72 is performed as stated above, the CPU 71 corrects the control value obtained from the first and the second thermistors 56a and 56b or the third and the fourth thermistors 61a and 61b. Accordingly, it is prevented that the control value becomes different from the actual supply power value due to the installation environment of the image forming apparatus 1 and the variation in the characteristic, and the fixing performance is influenced, and the excellent fixing performance can be obtained.

Besides, in the period when the surface temperature of the heat roller 20 is feedback controlled by the inverter drive circuit 72 as stated above, in the case where the control of the inverter drive circuit 72 becomes impossible due to a malfunction and the surface temperature of the heat roller 20 exceeds a threshold value, the first or the second thermostat 57a or 57b or the third or the fourth thermostat 62a or 62b detects the trouble, and the inverter drive circuit 72 is forcibly turned off.

Incidentally, although the temperature gradient of the heat roller 20 used for setting the correction value for correcting the actual supply power value is not limited to the region of 100° C. or lower, it is preferable that the correction value is set by using the temperature gradient characteristic before the temperature gradient of the heat roller 20 becomes low angle. Besides, the correction value for correcting the actual supply power value may be obtained by comparing the temperature gradient characteristic of the belt 33 with the reference temperature gradient characteristic.

According to the fixing apparatus 11 of this embodiment, the auxiliary pressure member 42 to press the belt 33 to the heat roller 20 side is provided, so that the width of the nip 37 can be widened without increasing the load of the nip 37. Accordingly, especially when fixing is performed continuously, the reduction in the surface temperature of the heat roller 20 and the press roller can be decreased. As a result, in the case where fixing is performed by the heat roller 20 and the belt 33 at the time of continuous fixing, the non-offset region can be widened, and the fixing property can be improved. Besides, a wait time for waiting until the fixing temperature, which was reduced at the time of the continuous fixing, is returned to the fixable temperature can be shortened.

Further, according to the fixing apparatus 11 of the first embodiment, the second fixing motor 36b for rotating the belt 33 is used to rotate the belt mechanism 30, and moves the belt 33 to come in contact with or to be spaced from the heat roller 20. By this, the belt 33 does not apply a load to the heat roller 20 except for the necessary time, the foam breakage of the foamed silicone rubber layer 20b of the elastic roller 21 is reduced, and the life of the elastic roller 21 can be prolonged. Further, since the belt mechanism 30 is rotated while the axis 32a of the metal roller 32 is made the rotation center, the belt 33 can be heated even when the heat roller 20 and the belt 33 are spaced from each other.

Further, according to the fixing apparatus 11 of the first embodiment, the temperature gradient characteristic of the surface temperature of the heat roller 20 is compared with the reference temperature gradient characteristic, and the correction value of the power supplied to the first and the second induction current generating coils 50a and 50b or the third and the fourth induction current generating coils 60a and 60b is set. By this, the CPU 71 controls the inverter drive circuit 72 to obtain the control supply power in which the correction value is added. Accordingly, irrespective of the variation of the characteristic of the power source voltage, the necessary power is supplied to the first and the second induction current generating coils 50a and 50b or the third and the fourth induction current generating coils 60a and 60b. As a result, the heat roller 20 or the belt 33 can obtain the desired temperature more certainly, and the fixing performance can be improved. Further, in the case where the correction value of the power is set, the temperature gradient characteristic of the surface temperature of the heat roller 20 before the heat roller 20 reaches 100° C. is used, and the temperature gradient is high angle, and therefore, as compared with the case where the temperature gradient is low angle, the resolution for correction can be improved. Accordingly, the correction value can be obtained at higher speed and more certainly.

Incidentally, this invention is not limited to the above embodiment, and can be variously modified within the scope of the invention. For example, the shape or structure of the pressing member is arbitrary. Further, the width of the nip formed by the pressing member and the magnitude of the load are not limited. Besides, the timing of measurement of the correction value of the power supplied to the first induction current generating device or the second induction current generating device is not limited, and the measurement may be performed only when the power source is turned on, or may be performed as the need arises.

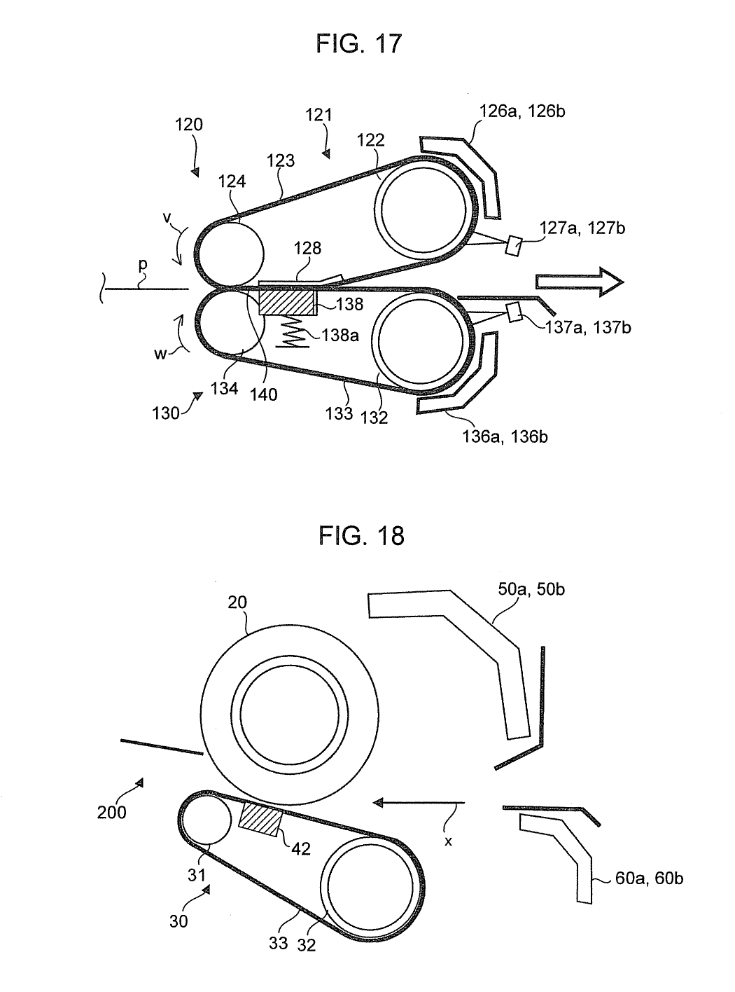

Further, the structure of the fixing apparatus is not limited, and the heat generating member is not limited to the roller, and may be belt-shaped like a fixing apparatus 120 of a first modified example shown in FIG. 17. This modified example includes a second belt mechanism 121 in which a second belt 123 rotated in an arrow v direction is supported by a second metal roller 122 and a second opposite roller 124. The metal roller 122 is induction heated by a fifth and a sixth induction current generating coils 126a and 126b. The surface temperature of the second belt 123 is detected by a fifth and a sixth thermistors 127a and 127b. Besides, in the fixing apparatus 120, a third belt mechanism 130 in which a third belt 133 rotated in an arrow w direction is supported by a third metal roller 132 and a fourth opposite roller 134 is disposed to be opposite to the second belt mechanism 121. The metal roller 132 is induction heated by a seventh and an eighth induction current generating coils 136a and 136b. The surface temperature of the third belt 133 is detected by a seventh and an eighth thermistors 137a and 137b.

A nip 140 is formed by a plate 128 made of silicone rubber in the second belt mechanism 121 and a second auxiliary pressure member 138 in the third belt mechanism 130, which is made of silicone rubber and to which a load is applied by a second pressing spring 138a.

Further, the structure of the fixing apparatus is not limited, and all of the first induction current generating device and the second induction current generating device, together with the heat generating member and the belt, may be unitized. Alternatively, like a second modified example shown in FIG. 18, a heat roller 20 and a belt mechanism 30 are integrated to form a unit 200, and a first and a second induction current generating coils 50a and 50b and a third and a fourth induction current generating coils 60a and 60b may be mounted at the main body side. The unit 200 is slid and moved in an arrow x direction, and is taken out from a main body of an image forming apparatus 1. By doing so, the weight of the unit 200 can be reduced, and the cost can be further reduced.

What is claimed is:

1. A fixing apparatus of an image forming apparatus, comprising:
a heat generating member comprising a metal layer;
a first induction current generating device disposed close to the heat generating member;
a belt that is opposite to the heat generating member, is rotatably supported by a plurality of rollers, and comes in contact with the heat generating member; and
a pressing member that presses the belt to the heat generating member and forms a nip between the heat generating member and the belt at a time when the heat generating member and the belt come in contact with each other.

2. The fixing apparatus of the image forming apparatus according to claim 1, wherein the pressing member comprises an auxiliary pressure member that is brought into contact with an inner periphery of the belt and a spring member that presses the auxiliary pressure member in a direction toward the heat generating member.

3. The fixing apparatus of the image forming apparatus according to claim 1, wherein a pressing force of the belt to the heat generating member by the pressing member forms a load distribution in a width of the nip.

4. The fixing apparatus of the image forming apparatus according to claim 3, wherein the pressing member comprises an auxiliary pressure member that is brought into contact with an inner periphery of the belt and a spring member that presses the elastic member in a direction toward the heat generating member, and
hardness of the auxiliary pressure member varies in a rotation direction of the belt.

5. The fixing apparatus of the image forming apparatus according to claim 4, wherein the auxiliary pressure member is divided into a plurality of blocks in the rotation direction of the belt.

6. The fixing apparatus of the image forming apparatus according to claim 1, further comprising a second induction current generating device opposite to a metal roller as one of the plurality of rollers through the belt, wherein the second induction current generating device induction-heats the metal roller.

7. The fixing apparatus of the image forming apparatus according to claim 1, further comprising a movement mechanism to integrally and movably support the belt and the pressing member.

8. The fixing apparatus of the image forming apparatus according to claim 1, wherein the heat generating member comprises a metal belt comprising the metal layer and an elastic roller disposed inside the metal belt and comprising an elastic layer.

9. The fixing apparatus of the image forming apparatus according to claim 1, wherein the heat generating member comprises a plurality of rollers at least one of which comprises the metal layer and a second belt supported by the plurality of rollers.

10. A fixing apparatus of an image forming apparatus, comprising:
a heat generating member comprising a metal layer;
a first induction current generating device disposed close to the heat generating member;
a belt mechanism comprising a belt that is opposite to the heat generating member, is rotatably supported by a plurality of rollers, and comes in contact with the heat generating member, and a pressing member that presses the belt to the heat generating member at a time when the heat generating member and the belt comes in contact with each other and forms a nip between the heat generating member and the belt;
a movement mechanism that moves the belt mechanism to release a pressing force of the belt mechanism to the heat generating member; and
a second induction current generating device that is disposed around the belt and heats the belt by induction heating.

11. The fixing apparatus of the image forming apparatus according to claim 10, wherein the plurality of rollers comprises an opposite roller disposed to be opposite to the heat generating member and a metal roller spaced from the heat generating member, and the second induction current generating device induction-heats the metal roller.

12. The fixing apparatus of the image forming apparatus according to claim 11, wherein the movement mechanism moves the belt mechanism while an axis of the metal roller is made a rotation axis, and spaces the belt from the heat generating member.

13. The fixing apparatus of the image forming apparatus according to claim 12, during a period when the belt is spaced from the heat generating member, the metal roller is induction-heated by the second induction current generating device.

14. The fixing apparatus of the image forming apparatus according to claim 11, wherein the movement mechanism moves the belt mechanism while an axis of the opposite roller is made a rotation center.

15. The fixing apparatus of the image forming apparatus according to claim 11, wherein the opposite roller is opposite to the heat generating member through a space.

16. The fixing apparatus of the image forming apparatus according to claim 10, wherein the heat generating member comprises a metal belt comprising the metal layer and an elastic roller disposed inside the metal belt and comprising an elastic layer.

17. The fixing apparatus of the image forming apparatus according to claim 10, wherein the heat generating member comprises a plurality of rollers at least one of which comprises the metal layer and a second belt supported by the plurality of rollers.

18. A fixing apparatus of an image forming apparatus, comprising:
a heat generating member comprising a metal layer;
a first induction current generating device disposed close to the heat generating member;
a belt mechanism comprising a belt that is opposite to the heat generating member, is rotatably supported by a plurality of rollers, and comes in contact with the heat generating member, and a pressing member that presses the belt to the heat generating member at a time when the heat generating member and the belt come in contact with each other and forms a nip between the heat generating member and the belt; and
a second induction current generating device that is disposed around the belt and heats the belt by induction heating;
wherein the heat generating member and the belt mechanism are unitized, the heat generating member is spaced from the first induction current generating device, and the belt mechanism is spaced from the second induction current generating device.

19. The fixing apparatus of the image forming apparatus according to claim 18, wherein the heat generating member and the belt mechanism which are unitized are integrally slid and moved in a vertical direction to axes of the plurality of rollers.
